(19) United States
(12) Patent Application Publication
(10) Pub. No.: US 2011/0299931 A1
(43) Pub. Date: Dec. 8, 2011

(54) Containment Boom

(76) Inventor: David John SCHAUS, Hong Kong (HK)

(21) Appl. No.: 12/792,397

(22) Filed: Jun. 2, 2010

(51) Int. Cl. E02B 15/06; B23P 17/04

(52) U.S. Cl. 405/63; 29/428

(57) ABSTRACT

A containment boom 200 is disclosed which is comprised of a flexible pouch 201, which is a PVC pouch 201 having a mouth 202 that can be closed by manual closure device such as Velcro closing, and a floatation 103 such as a foam which is inserted into the pouch 201. One or more belts 203 can be cinched around the pouch 201 to secure the floatation 103 in place. The floatation 103 can be assembled in a location near a crude oil spill in the sea as there is no need for tools to seal the pouch 201. This drastically reduces the costs of transporting a pre-assembled containment boom 200 from a factory located far away.

### FIELD OF INVENTION

This invention relates to containment booms for segregating and isolating floating oil and/or other floating hazardous/noxious substances such as in a crude oil spill in the sea.

### BACKGROUND OF THE INVENTION

One of the unfortunate ways in which the environment can be harmed is in discharge of crude oil from crude oil wells or from ships carrying crude oil, bunkers or other hazardous substances. A large spill of crude oil is directly detrimental to marine life, and indirectly to non-marine animals such as sea birds which depend on marine life for food. If a spill of crude oil is not contained immediately, the crude oil can get carried by weather and environmental influences over great distances to pollute beaches and damage terrestrial life.

It has been proposed to contain such crude oil spills by forming a floating physical barrier on the sea surface. Typically, such a barrier is made up of an arrangement of floats called containment booms, which are designed to be capable of being linked one to another to form an extended barrier over a long distance, and is flexible enough to be placed such that the barrier encircles the crude oil spill.

A containment boom generally comprises a barrier made of an impermeable material and which can float partially above and below the surface of the water. The containment boom has several pouches, in each of which is a foam floatation to provide the required buoyancy. Either end of the containment boom is provided with fixtures for connection to an end of another containment boom so that a chain of containment booms can form a continuous barrier. Typically, these fixtures are ASTM standard containment boom connectors, also known as Z-connectors, or rope connectors.

As containment booms are supposed to be used as a barrier for spilled crude oil, typically the containment booms are manufactured in such lengths to minimize the number of connectors. The number of containment booms required to contain the spill is determined by the size of the spill. The containment booms are linked together via the connectors to encircle or provide a barrier for the spreading of the spill.

Presently, a containment boom is entirely produced as an integral piece in the factory. The pouches are typically made of impermeable material such as PVC coated fabric and the floatation is typically a moulded closed cell polystyrene or other foam or floatation that resists degradation from contact with petroleum products. After a floatation foam is placed into a pouch, the pouch is typically heat-bonded, radio frequency (RF) bonded, sewn or vulcanised. All these processes make a permanent seal on the pouch, sealing the floatation foam within the pouch. However, making the seal requires special factory tools and a factory environment, as well as suitably skilled labour. This means that a containment boom must be completely manufactured in a location where the skilled labour and essential tools are available.

Typically, the completed containment boom is stored until an emergency such as a crude oil spill accident requires the containment boom to be deployed. Thus, each containment boom has to be inefficiently transported to the location of deployment as a single voluminous and bulky piece.

Crude oil spills can happen anywhere in the world and containment booms may have to be transported across the world to reach the site where the containment booms are needed. It is not economically viable to store or manufacture sufficient containment boom in every location where a major spill could occur, thus, the deployment of the containment booms may be at an unexpected distance away from where the containment booms are stored or manufactured. Air freight over these distances can be extremely costly and unpredictable, but yet the containment boom transportation must be done almost immediately.

Unfortunately, it is not possible to manufacture containment booms or store them in locations where crude oil spills are likely to occur, because since no one knows where and when these would happen.

The floatation inside the containment boom is the singular cause of the largest portion of air freight costs. This is because air freight is charged by weight with the caveat that low weight items (such as oil containment booms) will be charged at minimum Weight per Cubic Meter occupied in the aircraft

Therefore, it is desirable to provide a type of containment boom which can mitigate the financial costs in transportation and indirectly makes it more feasible for larger size containment booms to be manufactured, transported and used, thereby more efficiently containing a crude oil spill.

In many cases, smaller and less effective containment booms are used due to a finite amount of airfreight capacity as well as the cost of airfreight. A containment boom that minimizes the space required for air shipment presents a significant advantage.

Furthermore, despite the discussed constraints, it is desirable to provide a method of manufacturing containment booms which allow containment booms to be manufactured where the required machinery and skilled manpower is located and then economically transported to and or compactly stored close to the actual or potential area of usage.

### SUMMARY OF THE INVENTION

In the first aspect, the invention proposes a containment boom comprising a pouch, a floatation that is insert-able into the pouch, wherein the pouch can be closed manually to contain the floatation within the pouch.

Therefore, the invention provides the possibility that unskilled workers can close the pouch manually; this relieves the need for specialist tools or dedicated factory environment for the assembly of the float into the pouch.

More advantageously, the pouch and the floatation can be brought together in a location for assembly by manual workers, which can be any factory site with basic facilities near the oil spill.

By allowing the assembly of the containment boom to be done manually, the invention provide the possibility that the pouch is made in one part of the world while the floatation is made in another part of the world.

The pouch, being the most complicated part of the containment boom can be made in a factory where there are skilled workers to produce the pouch in the most cost effective way.

On the other hand, the floatation is typically only a moulded piece of foam and can be easily made in a factory in any country, since the level of technology in foam production is not high and foam is producible in almost all countries. There is typically no special requirement to the shape of the floatation except that it can fit well into and fill the pouch. Thus, the floatation and the required mould can be quickly commissioned and made at the last minute in any foam factory near the location of a spill requiring a containment boom.

In the prior art, the low weight but high volume of the typical floatation makes transportation very cost-inefficient. Therefore, the invention possibly addresses this problem by providing the possibility that the pouch of a containment boom may be manufactured in a location where the required skilled manpower and machinery are available, and then compactly, efficiently and cost-effectively transported by sea or air freight to a destination near the oil spill, where unskilled workers can insert the floatation and close the pouch manually. This dramatically reduces air freight costs in the event of a major spill, which is often due to sudden and urgent demands for a large number of containment booms.

Furthermore, manual sealing of the pouch provides the possibility of allowing the pouch to be manually opened and the floatation removed. This can be a significant advantage during decontamination procedures as well as has the potential to lower demobilisation costs.

Preferably the pouch have a mouth or opening for receiving the floatation, and the mouth or opening has lips or edges to which Velcro are attached; wherein the Velcro may be manually sealed without the requirement for specialty machinery or skilled labour.

Preferably, the pouch is made of a flexible material. Therefore, the pouch can be folded and transported in a compact configuration to the location of a crude oil spill. The compactness of the transportation helps to reduce the overall volume and makes transportation cheaper in some instances.

In the Gulf Crude oil Spill, pollution control companies are transportation crude oil containment booms to the United States from overseas location at air freight costs of USD 5 to 15 per foot. In many cases the cost of the air freight exceeds the price of the containment boom. The invention provides the possibility that air freight costs is dramatically reduced and valuable air freight capacity is conserved to maximize the amount of crude oil containment booms that can be brought to respond to the crude oil spill.

Typically, the pouch is elongate, having a length and a breath. In one embodiment, the mouth of the pouch is aligned substantially parallel to the breath of the pouch. This provides that the pouch has a mouth smaller than a mouth that is aligned along the length of the pouch. Advantageously, this provides the possibility that the floatation is more securely contained within the pouch due to the smaller mouth, despite manual assembly.

Furthermore, invention provides the possibility of re-opening the pouch. This allows the floatation to be replaced if necessary, and also allow the dismantling of the containment booms into a flat and easily folded containment boom and floatation. This means that transportation of the containment booms back to storage after an oil spill has been cleaned up can also be cost-effective.

Examples of means that allow the pouch to be close manually are devices such as belts and the Velcro, zippers, buckles or grommets, and so on.

The term “floatation” includes all variations of buoyancy means that can be inserted into the pouch, even small pieces of foams, gaseous, solid or liquid means.

In a second aspect, the invention proposes a pouch for making a containment boom, wherein a floatation that is insert-able into the pouch, wherein the pouch can be closed manually to contain the floatation within the pouch.

Preferably the pouch have a mouth or opening for receiving the floatation, and the mouth or opening has lips or edges to which Velcro, zippers, buckles or grommets are attached; wherein the Velcro, zippers, buckles or grommets may be manually sealed, zipped, fastened or laced without the requirement for specialty machinery or skilled labour.

In the event that the Velcro, zippers, buckles or grommets require additional reinforcement in the event the pouch experiences strain or impact, the pouch may be reinforced by a rope, cable, strap or belt that may be manually fastened to provide additional strength and durability to the pouch.

The method for manually closing the rope, cable, strap or belt includes buckles, Velcro, grommets, nut and bolt which may be appropriately cinched, sealed, swaged, laced, or screwed together

Preferably, the rope, cable, strap or belt may be made of nylon, Kevlar, steel, hemp or any other material with flexibility and tensile strength.

Preferably, the containment boom has numerous pouches or is an elongated pouch with a connector at each end wherein a plurality of the containment booms can be joined to form a continuous barrier.

In a third aspect, the invention proposes floatation for making a containment boom as described.

In a fourth aspect, the invention proposes a method for assembly a containment boom comprising the steps of manufacturing a pouch for the containment boom in a first location, manufacturing a floatation in a second location, transporting the pouch to a place, transporting the floatation to the same place, inserting the floatation into the pouch, and closing the pouch over the float to complete the containment boom.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 illustrates a prior art to the invention;

FIG. 2 illustrates a part of an embodiment of the invention;

FIG. 2a illustrates an ASTM-connector that can be used with the embodiment of FIG. 2;

FIG. 2b illustrates an embodiment of FIG. 2 which is completed;

FIG. 3 illustrates how the embodiment of FIGS. 2 and 2b can be deployed;

FIG. 4 illustrates the embodiment in actual use;

FIG. 5 illustrates a second embodiment of the invention; and

FIG. 6 illustrates a third embodiment of the invention.

### DESCRIPTION OF AN EMBODIMENT

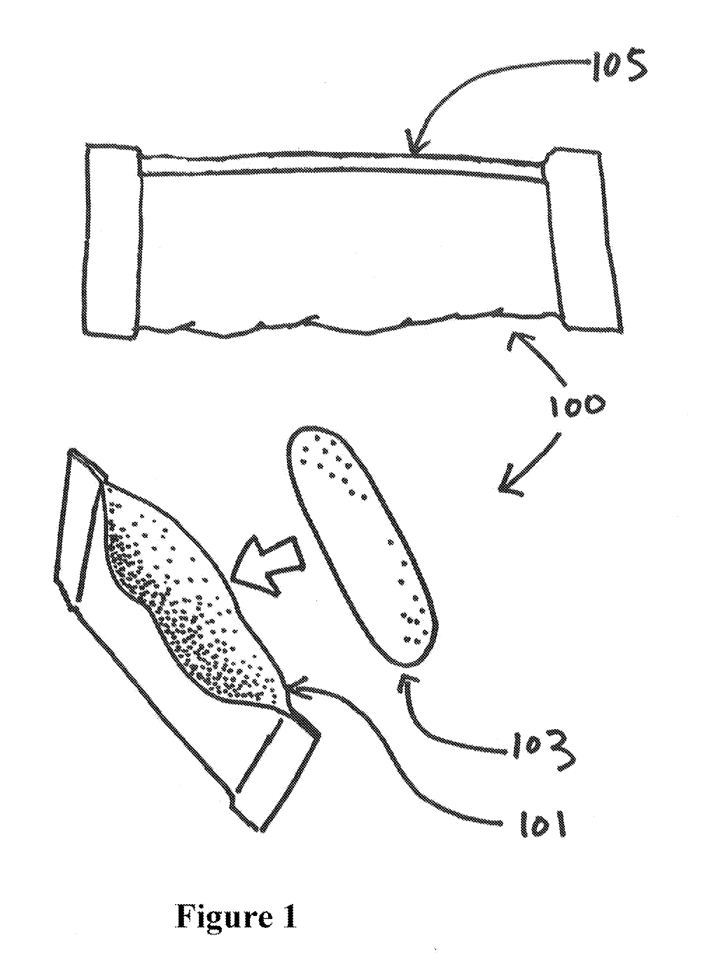

FIG. 1 shows a prior art which is a containment boom 100 that is manufactured of a pouch 101 that contains a floatation foam 103, i.e. a float. The entire containment boom 100 is produced as an integral piece in one factory. The pouch is typically made of an impermeable and flexible material like PVC or rubber coated fabric. The floatation 103 is typically moulded foam. After the floatation 103 is placed into the pouch in the factory, the pouch 101 is heat pressed or sewn, and permanently sealed 105 to finish the containment boom 100. The containment boom 100 is then stored until a situation such as a crude oil spill accident requires the containment boom 100 to be transported to the location of the crude oil spill for deployment. To be deployed, the containment boom 100 is placed onto the surface of the sea where the oil spill is, and floats partly submerged into the sea and partly emerging from the sea surface. Thus, a barrier is formed on the sea surface preventing the crude oil from migrating pass the containment boom 100.

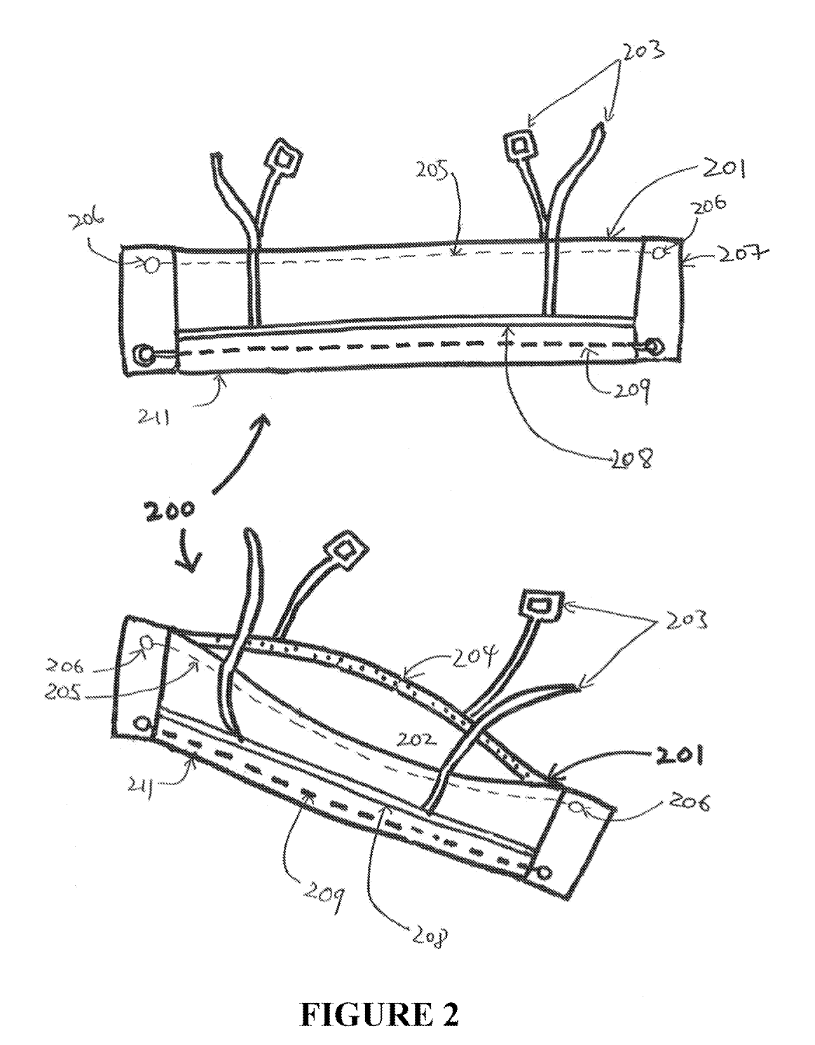

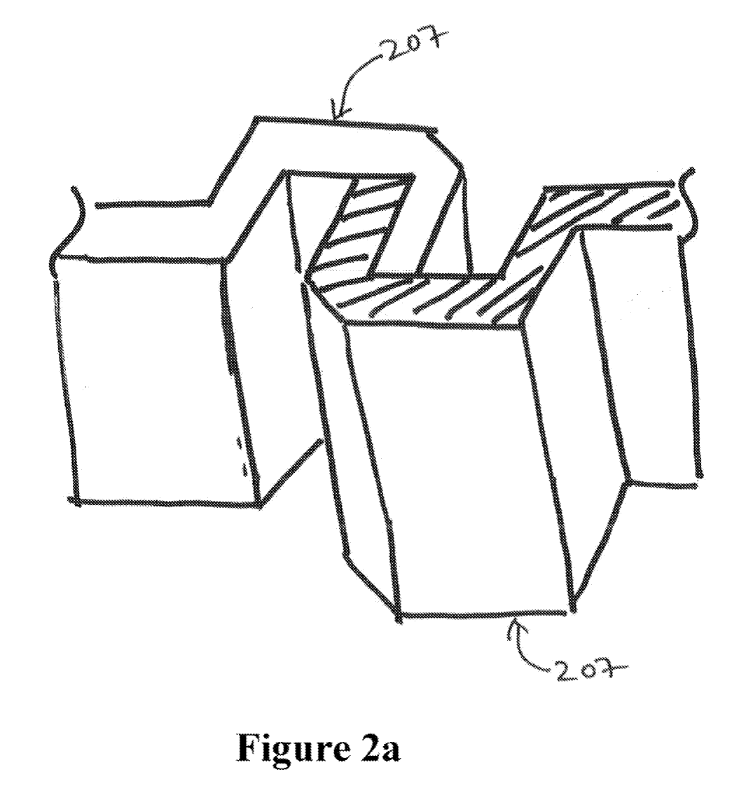

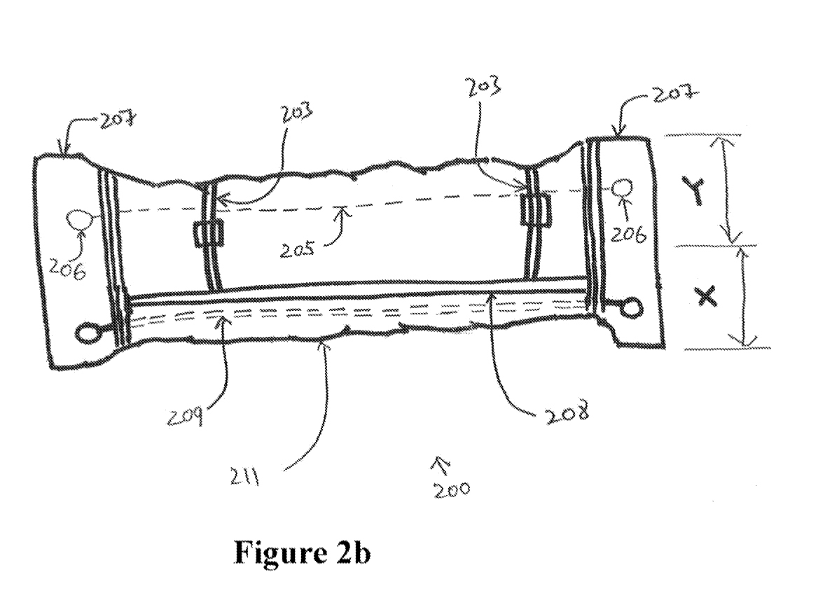

FIG. 2 shows a part of an embodiment 200 of the present invention comprising, among other features, a pouch 201 which is capable of containing a suitably sized floatation 103. The pouch 201 is made of a flexible material which allows the pouch 201 to be adjusted over a floatation 103. Typically, the material is 20 to 40 ounce polyvinyl chloride (PVC) coated fabric or other impermeable fabric. The fabric can be chosen to provide further tensile resistance against impact and tugging caused by wave movements on the sea. The PVC is of a composition which is suitable for withstanding erosion by the elements in sea environment, such as the sun, water and the salt, and is also suitable for long-term contact with crude oil from the oil spill.

The pouch 201 has a mouth 202 for insertion of the floatation 103. Although not necessary, the mouth 202 is preferably a slit along length of the pouch. The inner lips 204 of the mouth 202 are lined with Velcro material, so that the mouth 202 of the pouch 201 can be closed manually.

In this embodiment, the containment boom 200 comprises a single elongated pouch 201, and has two extreme ends. Each end of the containment boom is bolted to an ASTM-connector 207 (American Standard Test Method). The ASTM-connector 207 is for engaging the end of one containment boom 200 to the end of another containment boom 200 in order to form a chain of containment booms 200. FIG. 2a illustrates a close-up view of how one ASTM-connector 207 is coupled to another ASTM-connecter.

At appropriate locations along the length of the containment boom 201 are one or more belts 203. Preferably, the belts 203 are nylon straps that are provided with buckles so that the belts 203 can be cinched over the mouth 202 of the pouch 201. The belts 203 are sewn or sealed to the bag 201 to be mechanically able to resist separating from the bag 201 when wave movements created a tugging action on the belts 203.

The pouch 201 is also reinforced mechanically to be resistant to damage by wave movements in several other ways. For example, a top cable 205 of galvanised steel is threaded through the pouch to extend along a side of the pouch 201, from one end of the pouch 201 to the other end. The top cable 205 is shackled, at 206, to each of the ASTM-connectors 207 of the pouch 201. Thus, the top cable 205 provides extra resistance to the ASTM-connectors 207 on either end of the pouch 201 from being pulled so far apart that the ASTM-connectors 207 come loose of the pouch 201 or tear the pouch 201.

A nylon belt 208 is also sewn along the length of the pouch 201 to further increase the tensile strength of the pouch 201 lengthwise.

Typically, while the Velcro at the lips of the mouth 202 closes the pouch 201 over the floatation 103, the Velcro is not required to be load bearing against the floatation 103. Instead, when belts 203 are cinched or buckled up, the belts 203 form a tight mechanical hold on the pouch 201 and the inserted floatation 103 to securely strap the floatation 103 within the pouch 201.

The cinched belts 203 and the Velcro provide the possibility of re-opening the pouch 201 manually, and to allow the floatation 103 to be replaced by hand if necessary, and also to allow dismantling of the containment boom 200.

Ballasts 209 are attached to the skirt 211 of the containment boom 200 to ensure that the skirt 211 of the containment boom 200 submerges into the sea, and is aligned to point vertically downward. The ballasts 209 can be rubber coated pieces of metal attached to the skirt side 211 of the pouch 201, or a metal chain threaded through the skirt side of the pouch 201 (as shown in the drawings), or other variations which the skilled man will know.

Generally, the internal dimensions of the pouch 201 provide sufficient room for the floatation 103 to be inserted into the pouch 201. Typically, the overall length and breath of the pouch 201 is 576 mm by 1200 mm but the actual dimensions may depend on the tidal and environmental conditions in the location where the containment boom 200 is expected to be deployed.

The floatation 103 is typically made of styrofoam, a form of polystyrene, or other material that can provide buoyancy to the assembled containment boom 200. Where the floatation 103 is made of styrofoam, the floatation 103 is typically blown up in a mould defining the shape of the floatation 103. In this embodiment the floatation 103 is an elongate piece that corresponds to the shape of the pouch 201.

FIG. 2b shows an example of the embodiment with the floatation 103 placed inside the pouch 201 and the belts cinched to complete the containment boom 200. The pouch 201 with lips 204 lined with a Velcro closure and nylon belts 203 with buckles can be closed manually by a person, to hold the floatation 103 in place. ‘Manually’ here means that only simple tools or no tools are required. Thus, the manually close-able mouth 202 relieves the requirement of special tools such as those required for heat-sealing, RF bonding or sewing the mouth 202 shut in a special factory setting. The floatation 103 can be made separately in another factory, and inserted and secured into the pouch 201 at or near the location where the containment boom 200 is to be deployed. This allows the pouch 201 to be manufactured and released from the factory without the floatation 103. The freight charge of the pouch 201 without a floatation 103 is only a fraction of the freight charge of a containment boom 200 with a floatation 103 sealed within.

The skilled reader understands that the combination of materials used for the floatation 103, the pouch 201 and the belts 203, and their dimensions, must provide a containment boom that has a ‘freeboard to skirt’ ratio that optimises the ability for the freeboard to prevent waves from going over the top and minimizes the ability of spill to go underneath the skirt. This ration is typically 1:2. This means that the dimensions of the containment boom 200, as well as the density of the material of the pouch 201 and the styrofoam should add up to provide a containment boom 200 which has an overall density such that a PVC skirt, marked ‘x’ in FIG. 2b, is submerged below the surface of the sea. The part marked ‘y’ is the freeboard that emerges from the surface of the sea. The ratio of y:x=1:2. This ensures that the crude oil floating on the top of the sea does not get over or under the containment boom 200.

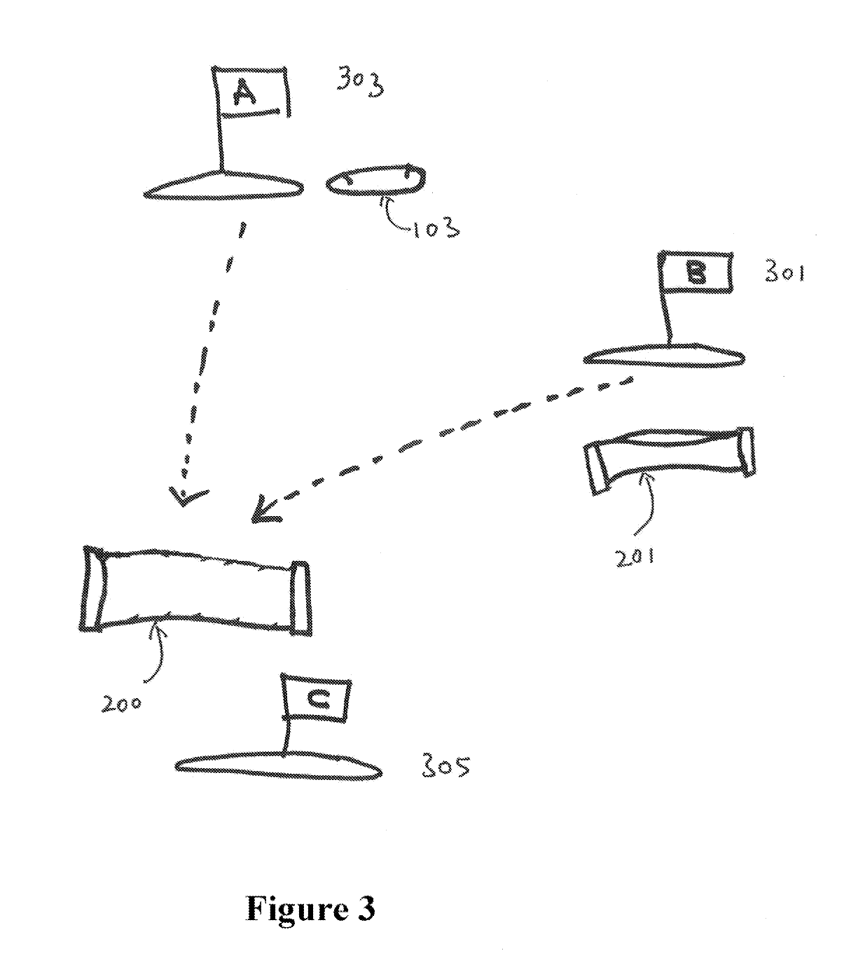

FIG. 3 illustrates how the pouch 201 is manufactured in a location or country 301 where the cost of manufacturing the pouch 201 is favourable commercially. Presently, these include countries such as China or Vietnam. In the case of a large crude oil spill, large amounts of containment booms 200 are generally required to be air freighted to the location of the oil spill. Unfilled pouches 201 can be folded and transported in a compact configuration to the location of a crude oil spill. The compactness of the unfilled pouches 201 reduces the overall volume and allows more pouches to be transported given a finite amount of air freight capacity.

The styrofoam material of the floatation 103 cannot be pressed down and made more compact or the styrofoam will lose its low density. Advantageously, high-end technology is not required to make the floatation 103, since the primary requirement is the floatation buoyancy and the floatation dimension to fit the pouch 201. Thus, the floatation 103 and the required mould for forming the floatation 103 can be quickly commissioned and made even at the last minute in any foam factory 305 near the location of a crude oil spill. Virtually all countries should have factories capable of making the floatation. Thus, the floatation 103 is moulded in any country 303, or factory 303, which is near a crude oil spill 305.

Thus, the embodiment allows floatations 103, which have the highest air freight cost, to be sourced from a supplier nearer to the oil spill and also allows the user to take advantage of manufacturing the pouches 201 in an area with a large amount of manufacturing capacity, and then moving the floatations 103 and pouches 201 in a cost effective manner to a location near to the oil spill for assembly.

In other words, the pouch 201 and the floatation 103 are made separately and subsequently brought together for assembly.

The pouch 201 having only a Velcro closing and belts to be cinched about the pouch 201 provides that an unskilled worker is able to secure the floatation into the pouch 201. This relieves the requirement of specialist tools to secure the floatation 103 into the pouch 201. For example, special tools for heat-sealing, RF bonding or sewing the pouch 201 are not required, which opens up the possibility of assembling the containment booms 200 in any factory 303 with only basic facilities near the crude oil spill 305. This allows any suitable factory near the crude oil spill to be used for assembling the pouch 201 and the floatation 103. Thus, transportation cost of the assembled containment booms 200 over the short distance to the crude oil spill is reduced, which is commercially advantageous since the transportation cost is the primary cost driver in the deployment of containment booms 200.

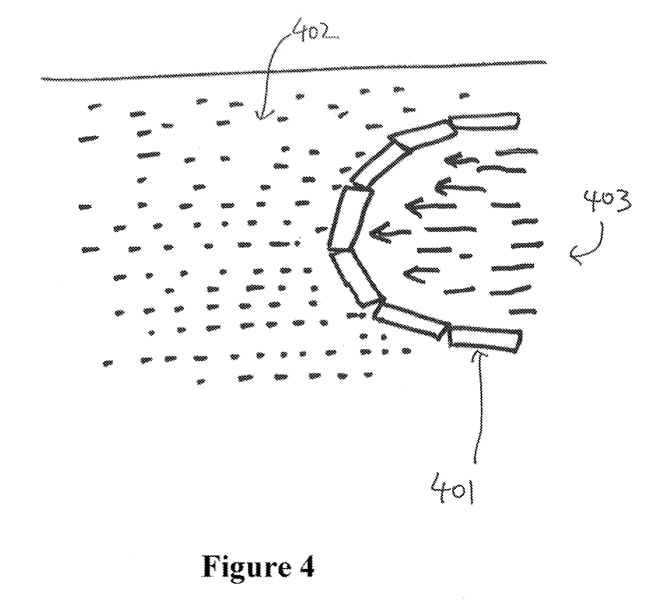

FIG. 4 illustrates a plurality of containment booms assembled by the ASTM-connector 207 into an extended barrier 401 effectively containing the spread of a crude oil spill 403 from reaching the sea surface 402 on the other side of the barrier 401.

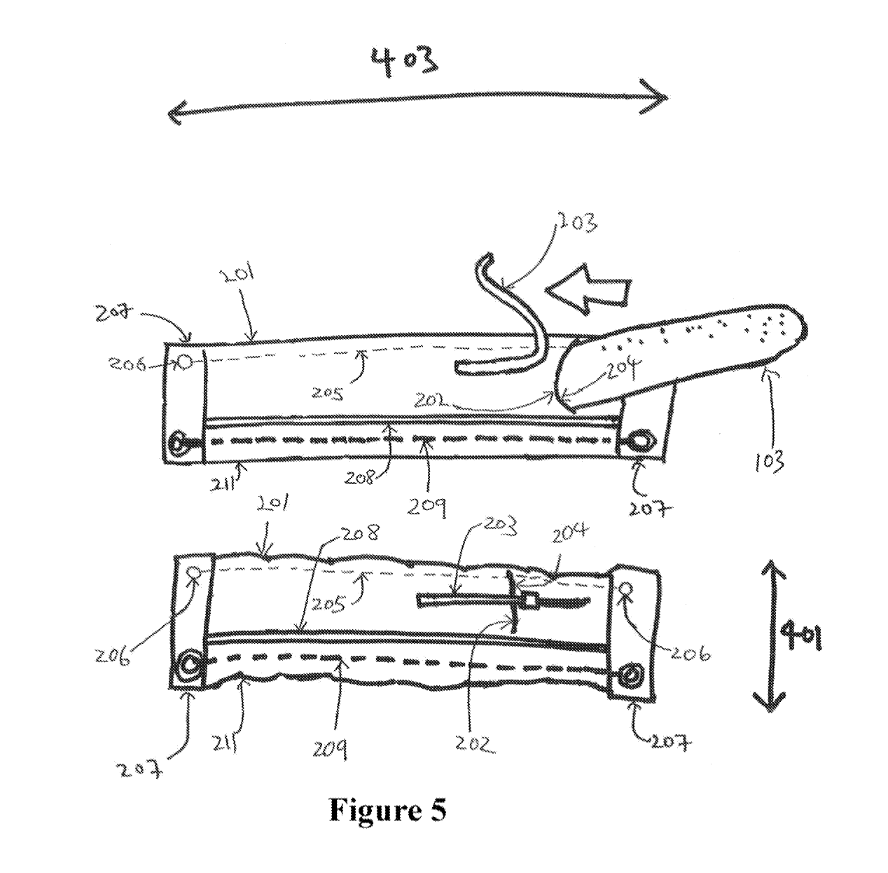

In another embodiment, the mouth 202 can be an opening at one end of the elongate pouch 201. Such a mouth 202 can be provided substantially along the ‘breath’ 501 of the pouch 201, as shown in FIG. 5. ‘Substantially’ means that the alignment of the mouth 202 need not be strictly parallel to the side of the pouch's breath 401 and can be slanted if required. Placing the mouth 202 of the pouch 201 in such a position provides that the pouch 201 has a shorter slit forming a smaller mouth 202, into which the floatation 103 is slipped. An advantage of this other embodiment is that the floatation 103 is more securely contained within the pouch 201 due to the smaller mouth 202, which is less prone to being opened wide by the tugging action of the waves on the belts 203. Furthermore, the smaller mouth 202 means a smaller number of belts 203 are required to secure the floatation 103 in the pouch 201. All the other features described for the first embodiment, such as the belt 203 placed along the length of the pouch 201 and the Velcro lined lips 204 can be included in this other embodiment without difficulty.

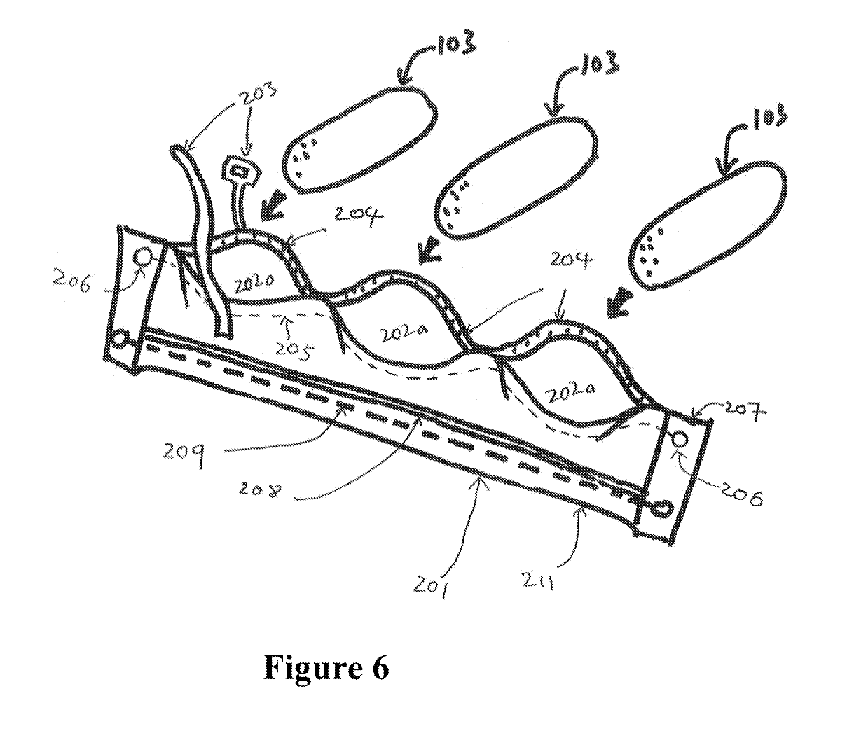

FIG. 6 illustrates a further embodiment in which a single container containment boom 200 is comprised of a series of integral pouches, i.e. a pouch 201 that is similar to the one in the first embodiment but has three pockets 202a instead of one pocket 202a. The floatation 103 that is inserted into each of these pockets 202a are sized accordingly to the smaller pockets 202a. The advantage of this embodiment is that, if one of the floatation 103 comes loose from on of the pockets 202a, there are still another two sustaining the containment boom 200 buoyancy until the lost floatation 103 is replaced.

Accordingly, a containment boom has been described which comprising a containment boom 200 comprising a pouch 201, a floatation 103 that is insert-able into the pouch 201, wherein the pouch 201 can be closed manually to contain the floatation 103 within the pouch 201. Furthermore, the pouch 201 has a mouth 202 for receiving the float 103, and a manual closure device, such as a Velcro closing, wherein the manual closure device can be used to close the mouth 202 manually. Furthermore, the containment boom 200 further comprises a manual securing device 203 to strengthen the closure of the mouth, such as a belt. In different embodiments, the mouth 202 of the pouch 201 is aligned substantially along the length of the breath of the pouch 201.

The embodiment is also a method for assembly a containment boom 200 comprising the steps of, manufacturing a pouch 201 for the containment boom 200 in a first location 301, manufacturing a floatation 103 in a second location 303, transporting the pouch 201 to a location 305 for assembly, transporting the floatation to the same location 305 for assembly, subsequently inserting the floatation 103 into the pouch 201 and closing the pouch 201 over the floatation 103 to complete the containment boom 200.

While there has been described in the foregoing description preferred embodiments of the present invention, it will be understood by those skilled in the technology concerned that many variations or modifications in details of design, construction or operation may be made without departing from the scope of the present invention as claimed.

For example, the pouch 201 can be entirely made of a rubber coated fabric instead of PVC coated fabric. Alternatively, the pouch 201 can also be a hard casing, made of a hard inflexible material such as appropriately additive-laden PVC or other a suitable plastic material.

Although the embodiment described a floatation 103 which is made of styrofoam, the skilled man understands that other means of providing buoyancy is possible, such as an air-filled canister in place of the styrofoam, or using foams of other kinds of material.

Furthermore, other than a single piece of floatation material as discussed, small size blocks of floatation devices such as foam blocks can also be used to fill the pouch 201. To do so, the pouch will have to be made to be able to contain the small blocks of floatation devices, such as having a smaller mouth 202. These variations are within the understanding of the skilled man.

The term ‘floatation’ includes all variations of buoyancy means that can be inserted into the pouch 201, even gaseous, solid or liquid means.

Furthermore, the skilled man understands that other than the Velcro closing, which lines the lips 204 of the mouth 202, various other means for manually closing the mouth of the pouch can be used instead. For example, zippers, buttons, buckles, grommets may be used to close the mouth 202 of the pouch 201. It is mentioned that the Velcro closing is non-load-bearing, and which is reinforced by the belts 203 to close the mouth 204 and to keep the floatation 103 within the pouch 201. However, the means for manually closing the pouch 201 may nevertheless be a load bearing one in some embodiments. For example, instead of the Velcro, the lips 204 can be closed by a lacing which can lace up the mouth 202 of the pouch 201.

Furthermore, at appropriate locations along the length of the containment boom 201, instead of belts 203, there may be may be ropes, cables, straps and so on for securing the floatation 103 inside the pouch 201. Typically, the ropes, cables, straps or belts 203 are made of Kevlar, steel, hemp or any other material with flexibility and tensile strength that may be cinched, sealed, swaged, laced, or screwed together to withstand the impact and tugging caused by sea waves.

Furthermore, although ASTM standard containment boom connectors 207 are described, other possibility of connecting one containment boom to another is possible, using Z-connectors, or rope connectors. In the case of a rope connector, the ends of each containment boom has reinforced holes in tabs of equal proportion to the size of the containment boom that can be placed on top of each other and a rope threaded between the tabs joining the two containment booms 200.

1. A containment boom comprising
a pouch,
a floatation that is insertable into the pouch, wherein the pouch can be closed manually to contain the floatation within the pouch.

2. A containment boom as claimed in claim 1 wherein
the pouch has a mouth for receiving the float, and
a manual closure device;
wherein the manual closure device can be used to close the mouth manually.

3. A containment boom as claimed in claim 2 wherein the manual closure device is Velcro.

4. A containment boom as claimed in claim 1, further comprising a manual securing device to strengthen the closure of the mouth.

5. A containment boom comprising as claimed in claim 4, wherein the manual securing device is a belt.

6. A containment boom comprising as claimed in claim 5, wherein the belt is a nylon strap.

7. A containment boom as claimed in claim 1, wherein the containment boom is elongate having two ends;
each end of the containment boom having a device for connected to an end of another containment boom;
whereby a plurality of containment booms can be joined to form a barrier.

8. A containment boom as claimed in claim 1, wherein the mouth of the pouch is aligned substantially along the breath of the containment boom.

9. A pouch for making a containment boom, wherein a floatation that is insert-able into the pouch, wherein the pouch can be closed manually to contain the floatation within the pouch.

10. A pouch for making a containment boom as claimed in claim 9, wherein the pouch has a mouth for receiving the float, and
a manual closure device; wherein the manual closure device can be used to close the mouth manually.

11. A containment boom as claimed in claim 10 wherein the manual closure device is Velcro.

12. A pouch for making a containment boom as claimed in claim 9, further comprising a manual securing device to strengthen the closure of the mouth.

13. A pouch for making a containment boom as claimed in claim 12, wherein the manual securing device is a belt.

14. A pouch for a containment boom as claimed in claim 13, wherein the belt is a nylon strap.

15. A pouch for making a containment boom as claimed in claim 9, wherein the containment boom is elongate having two ends;
each end of the containment boom having a device for connected to an end of another containment boom;
whereby a plurality of containment booms can be joined to form a barrier.

16. A pouch for making a containment boom as claimed in claim 9, wherein the mouth of the pouch is aligned substantially along the breath of the containment boom.

17. A floatation for insertion into the pouch of a containment boom, as claimed in claim 1.

18. A method for assembly a containment boom comprising the steps of:
manufacturing a pouch for the containment boom in a first location;
manufacturing a floatation in a second location;
transporting the pouch to a place;
transporting the floatation to the same place;
inserting the floatation into the pouch; and
closing the pouch over the float to complete the containment boom.

19. A method for assembly a containment boom as claimed in claim 18, wherein the step of closing the pouch comprises
closing the pouch over the floatation by Velcro means; and
strapping the pouch to prevent the pouch from opening.
